(19) United States
(12) Patent Application Publication
(10) Pub. No.: US 2010/0150081 A1
(43) Pub. Date: Jun. 17, 2010

(54) PHYSICAL UPLING CONTROL CHANNEL COMPRESSION SUPPORTING ACK/NACK BUNDLING

(75) Inventors: Chun Yan Gao, Beijing (CN); Xiang Guang Che, Beijing (CN)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/494,952

(22) Filed: Jun. 30, 2009

Related U.S. Application Data
(60) Provisional application No. 61/133,454, filed on Jun. 30, 2008.

(51) Int. Cl. H04W 72/04

(52) U.S. Cl. 370/329

(57) ABSTRACT

In one exemplary embodiment, a method includes: dividing a plurality of control channel elements in at least one downlink subframe of a bundling window into a plurality of portions having a first portion and a second portion, where the first portion includes at least one control channel element that is mapped to resources and the second portion includes at least one control channel element that is not mapped to resources, where the bundling window has a plurality of downlink subframes; and sending a last downlink grant in a downlink subframe of the bundling window using at least one control channel element that is mapped to resources.

### CROSS-REFERENCE TO RELATED APPLICATIONS:

This patent application claims priority under 35 U.S.C. §119(e) from U.S. Provisional Patent Application No. 61/133,454, filed Jun. 30, 2008, the disclosure of which is incorporated by reference herein in its entirety.

### TECHNICAL FIELD

The exemplary and non-limiting embodiments of this invention relate generally to wireless communication systems, apparatus, methods and computer program products and, more specifically, relate to control signaling between a mobile user device and a wireless network access node.

### BACKGROUND

Various abbreviations that may appear in the specification and/or in the drawing figures are defined as follows:
3GPP third generation partnership project
ACK acknowledge
AN ACK/NACK
CCE control channel element
DAI downlink activity indicator
DL downlink (eNB towards UE)
eNB E-UTRAN Node B (evolved Node B)
EPC evolved packet core
E-UTRAN evolved UTRAN (LTE)
FDD frequency division duplex
FDMA frequency division multiple access
HARQ hybrid automatic repeat request
IP internet protocol
LTE long term evolution of UTRAN (E-UTRAN)
MAC medium access control (layer 2, L2)
MM mobility management
MME mobility management entity
NACK not (negative) acknowledge
Node B base station
O&M operations and maintenance
OFDMA orthogonal frequency division multiple access
PCFICH physical control format indicator channel
PDCP packet data convergence protocol
PHY physical layer (layer 1, L1)
PRB physical resource block (180 kHz)
PUCCH physical uplink control channel
PUSCH physical uplink shared channel
RB resource block
RLC radio link control
RRC radio resource control
SC-FDMA single carrier, frequency division multiple access
S-GW serving gateway
TDD time division duplex
UE user equipment, such as a mobile station or mobile terminal
UL uplink (UE towards eNB)
UTRAN universal terrestrial radio access network

The specification of a communication system known as evolved UTRAN (E-UTRAN, also referred to as UTRAN-LTE or as E-UTRA) is nearing completion within 3GPP. In this system the DL access technique will be OFDMA and the UL access technique will be SC-FDMA.

One specification of interest is 3GPP TS 36.300, V8.4.0 (2008-03), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8). One section of particular relevance to the ensuing discussion is Section 5.2, Uplink Transmission Scheme.

FIG. 1 reproduces FIG. 4 of 3GPP TS 36.300, and shows the overall architecture of the E-UTRAN system. The E-UTRAN system includes eNBs, providing the E-UTRA user plane (PDCP/RLC/MAC/PHY) and control plane (RRC) protocol terminations towards the UE. The eNBs are interconnected with each other by means of an X2 interface. The eNBs are also connected by means of an S1 interface to an EPC, more specifically to a MME (Mobility Management Entity) by means of a S1MME interface and to a Serving Gateway (SGW) by means of a S1U interface. The S1 interface supports a many-to-many relation between MMEs/Serving Gateways and eNBs.

The eNB hosts the following functions: functions for Radio Resource Management: Radio Bearer Control, Radio Admission Control, Connection Mobility Control, Dynamic allocation of resources to UEs in both uplink and downlink (scheduling); IP header compression and encryption of user data stream; selection of a MME at UE attachment;

routing of User Plane data towards Serving Gateway; scheduling and transmission of paging messages (originated from the MME); scheduling and transmission of broadcast information (originated from the MME or O&M); and measurement and measurement reporting configuration for mobility and scheduling.

Also of interest herein are the Layer 1 (PHY) specifications, such as those found in 3GPP TS 36.211 V8.2.0 (2008-03), 3rd Generation Partnership Project; Technical Specification Group Radio Access Network; Evolved Universal Terrestrial Radio Access (E-UTRA); Physical Channels and Modulation (Release 8), as well as 3GPP TS 36.213 V8.3.0 (2008-05), 3rd Generation Partnership Project; Technical Specification Group Radio Access Network; Evolved Universal Terrestrial Radio Access (E-UTRA); Physical Layer Procedures (Release 8).

Two different approaches have been discussed in 3GPP regarding the ACK/NACK signaling in TDD mode. A first approach can be referred to as ACK/NACK bundling (bundled-AN), where ACK/NACK feedback related to multiple DL sub-frames is compressed into a single ACK/NACK feedback transmitted via a single ACK/NACK resource. A second approach can be referred to as multi-ACK/NACK (multi-AN), where each DL subframe is considered as a separate HARQ process, and where a separate ACK/NACK feedback is transmitted for each (granted) DL subframe.

Of particular interest herein is the ACK/NACK bundling approach.

In R1-081110, “Multiple ACK/NACK for TDD”, Ericsson, Motorola, Nokia, Nokia Siemens Networks, Qualcomm, it was agreed that DL hybrid ARQ (HARQ) acknowledgments in TDD can be transmitted as a single ACK/NACK feedback, where ACK/NACKs from one or several DL subframes are combined (“bundled” by performing an AND operation of all ANs) into a single ACK/NACK report. The PUCCH formats already defined for LTE are reused (PUCCH Format 1 a/1b). This ACK/NACK mode has been referred to as “ACK/NACK-bundling” or more simply as “AN-bundling”.

In R1-082168 and R1-082100, “ACK/NACK Bundling for TDD: Way Forward”, Motorola, CATT, CMCC, Ericsson, Huawei, LGE, Qualcomm, Samsung, Tex. Instruments, it was agreed regarding AN bundling for UL/DL configurations (except configuration 5) that a 2-bit Downlink Assignment Index field is added to DCI formats 1, 1A, 1B and 2. The Downlink Assignment Index must be greater than or equal to the number of previously assigned subframes within the bundling window and must be less than or equal to the maximum number of dynamic assignments within the bundling window. It was also agreed that the UE uses the CCE index in a last received/detected dynamic DL assignment, as well as the subframe number, to check for missed DL assignments and to determine the UL ACK/NACK PUCCH index. It was also agreed that semi-persistent assignments are not counted in the Downlink Assignment Index.

In R1-082243, “CR for UL ACK/NACK procedure for TDD”, Motorola, it was agreed that the UE determines the UL ACK/NACK PUCCH index based on the lowest CCE index and downlink subframe number of the last received/detected dynamic assignment (the exact formula to use when determining the UL ACK/NACK PUCCH index was left for future study).

AN bundling is used when there are more downlink subframes than uplink subframes per radio frame. With the agreements previously made in 3GPP RAN1, each downlink subframe will have its unique PUCCH AN resources in association therewith, while the specified AN bundling feature will only require occupying a single PUCCH AN resource at a given time, regardless how many DL HARQ ANs have been “bundled” together. This implies that, for example, if the bundling window is 4 DL subframes, each UE will use only 1 out of 4 reserved PUCCH AN resources, while the remaining 3 PUCCH AN resources will be unused. As can be appreciated, this approach is wasteful when UL resources are scarce. This is particularly true, given the fact that UL is already in short supply when AN-bundling is applied (DL subframes>UL subframes).

R1-081816, “CCE to bundled ACK/NACK index mapping in TDD”, LG Electronics, and R1-081788, “Uplink ACK/NACK implicit mapping in TDD”, Huawei, partially address the PUCCH resource usage, but not the over-reservation per UE issue.

### SUMMARY

The below summary section is intended to be merely exemplary and non-limiting.

In one exemplary embodiment of the invention, a method comprising: dividing a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and sending a last downlink grant in a downlink subframe of the bundling window using at least one control channel element that is mapped to resources.

In another exemplary embodiment, a program storage device readable by a machine, tangibly embodying a program of instructions executable by the machine for performing operations, the operations comprising: dividing a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and sending a last downlink grant in a downlink subframe of the bundling window using at least one control channel element that is mapped to resources.

In another exemplary embodiment, an apparatus comprising: at least one processor; and at least one memory storing computer program code, the at least one memory and the computer program code configured to, with the at least one processor, cause the apparatus to perform at least the following: divide a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and send a last downlink grant in a downlink subframe of the bundling window using at least one control channel element that is mapped to resources.

In another exemplary embodiment, an apparatus comprising: means for dividing a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and means for sending a last downlink grant in a downlink subframe of the bundling window using at least one control channel element that is mapped to resources.

### BRIEF DESCRIPTION OF THE DRAWINGS:

The foregoing and other aspects of exemplary embodiments of this invention are made more evident in the following Detailed Description, when read in conjunction with the attached Drawing Figures, wherein:

FIG. 1 reproduces FIG. 4 of 3GPP TS 36.300, and shows the overall architecture of the E-UTRAN system;

FIG. 2 shows a simplified block diagram of various electronic devices that are suitable for use in practicing the exemplary embodiments of this invention;

FIG. 3 shows an exemplary embodiment implementing PUCCH compression with CCE division;

FIG. 4 shows an exemplary embodiment implementing PUCCH compression with respect to DL grant transmission;

FIG. 5 depicts a flowchart illustrating one non-limiting example of a method for practicing the exemplary embodiments of this invention;

FIG. 6 depicts a flowchart illustrating another non-limiting example of a method for practicing the exemplary embodiments of this invention; and

FIG. 7 shows two exemplary distributions of UE DL grants among four DL subframes in the time domain and four carriers in the frequency domain

### DETAILED DESCRIPTION:

Reference may be had to 3GPP TSG RAN WG1 Meeting #52bis, R1-08xxxx, “Managing PUCCH for ACK/NACK bundling in LTE TDD”, Shenzhen, China, Mar. 31 B Apr. 4, 2008, Nokia Siemens Networks, Nokia. In this approach PUCCH AN resources are compressed by mapping many DL CCE used for carrying the DL grants for the same UE into a single PUCCH AN resource. This technique avoids the over-reservation problem, i.e., only a single AN resource is reserved per UE. It can be noted in this regard that the hashing functions described in 3GPP TS 36.213 for defining the UE specific search space will cause a randomization of the starting points for a given UE at a given aggregation level. As a result, it becomes important to properly account for which resources are being blocked by other UEs having already reserved PUCCH AN resources.

Reference is further made to U.S. Provisional Patent Application No. 61/133,222, titled “Physical Uplink Control Channel ACK/NACK Indexing,” filed Jun. 25, 2008. For convenience, this document and exemplary embodiments of the invention described therein will be referred to herein as “the indexing provisional.”

One way to avoid wasting PUCCH resources is to utilize the unused PUCCH resources for data transmission. Some exemplary techniques for utilization of unused PUCCH resources for data transmission can be seen in the indexing provisional.

Another way to avoid wasting PUCCH resources is to compress the PUCCH resources reserved for AN-bundling. In one technique, the PUCCH AN resources are compressed by mapping many DL CCEs, used for carrying the DL grants for a same UE, into a single PUCCH AN resource. This can achieve the same goal by avoiding the over-reservation since only a single AN resource is reserved per UE. However, one cost for implementing this technique is that at least one limitation is applied to the packet scheduler. Reference in this regard may be made to EP Patent Application No. 08155058.4, filed Apr. 23, 2008.

R1-081816 is one contribution handling CCEs bundled to ACK/NACK index mapping in TDD. According to the proposal, some ACK resources are remapped, i.e., there can be two CCEs mapped to a same ACK resource. This method may reduce the reserved PUCCH resources, but there should be some limitation in the scheduler to avoid the collision of ACK transmissions. Moreover, if it is assumed that one UE is assigned four DL grants, then CCEs for the four DL grants transmission still map to four PUCCH resources. That is, the over-reservation problem mentioned above is still left unsolved.

Alternative compression techniques to compress the PUCCH resources reserved for AN-bundling are described below in further detail with respect to the exemplary embodiments of the invention. It is noted that the exemplary embodiments of the invention as described herein may be utilized in conjunction with one or more of the various exemplary embodiments described in the indexing provisional.

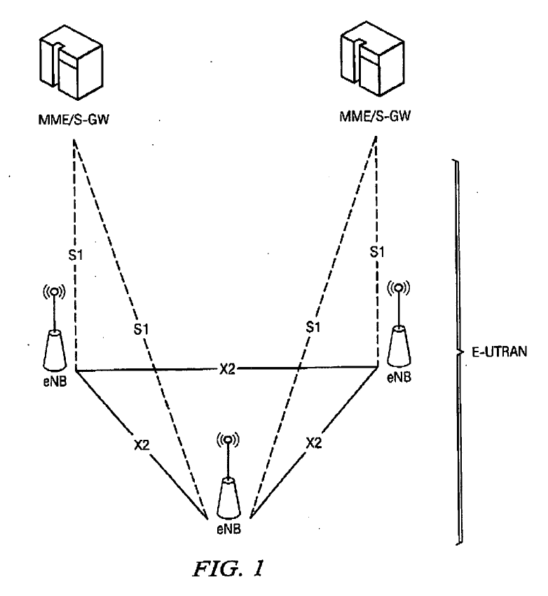

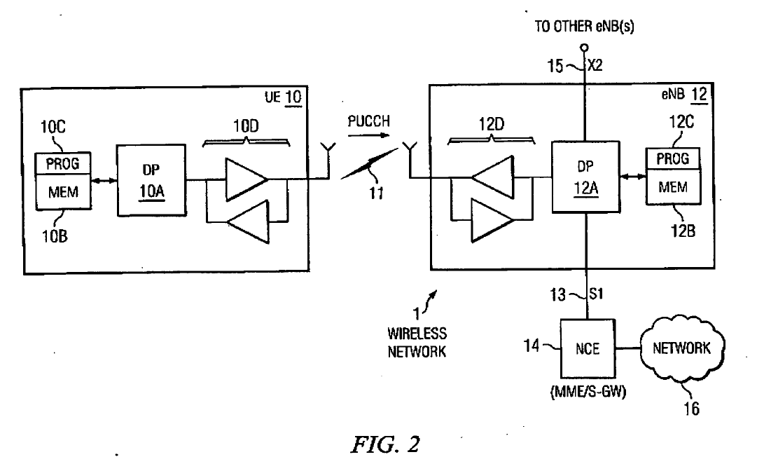

Reference is made to FIG. 2 for illustrating a simplified block diagram of various electronic devices that are suitable for use in practicing the exemplary embodiments of this invention. In FIG. 2 a wireless network 1 is adapted for communication with an apparatus, such as a mobile communication device which may be referred to as a UE 10, via a network access node, such as a Node B (base station), and more specifically an eNB 12. The network 1 may include a network control element (NCE) 14 that may include the MME/S-GW functionality shown in FIG. 1, and which provides connectivity with a network 16, such as a telephone network and/or a data communications network (e.g., the internet). The UE 10 includes at least one data processor (DP) 10A, at least one memory (MEM) 10B that stores at least one program (PROG) 10C, and at least one suitable radio frequency (RF) transceiver 10D for bidirectional wireless communications 11 with the eNB 12 via one or more antennas. The eNB 12 also includes a DP 12A, a MEM 12B that stores a PROG 12C, and a suitable RF transceiver 12D. The eNB 12 is coupled via a data path 13 to the NCE 14. The data path 13 may be implemented as the S1 interface shown in FIG. 1, for example. The PROGs 10C and 12C may be assumed to include program instructions that, when executed by the associated DP, enable the respective electronic device to operate in accordance with the exemplary embodiments of this invention, as will be discussed below in greater detail.

The exemplary embodiments of this invention may be implemented at least in part by computer software executable by the DP 10A of the UE 10 and/or by the DP 12A of the eNB 12, or by hardware, or by a combination of software and hardware.

In general, the various embodiments of the UE 10 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor based memory devices, flash memory, magnetic memory devices and systems, optical memory devices and systems, fixed memory and removable memory, as non-limiting examples. The DPs 10A, 12A and 14A may be of any type suitable to the local technical environment, and may include one or more of general purpose computers, special purpose computers, microprocessors, digital signal processors (DSPs) and processors based on multi-core processor architectures, as non-limiting examples.

In one non-limiting, exemplary embodiment of the invention, since a bundled AN will be sent from the PUCCH resource(s) mapped by the CCE of the last DL grant, then the CCEs in each DL subframe except the last DL subframe within the bundling window can be divided into two parts (i.e., at least two parts). Let a first part map to PUCCH resources while the second part remains unmapped. In this way, the reserved PUCCH resources can be reduced. In addition, the DL grant for one UE will be sent using CCEs in the unmapped part if it is not the last DL grant, while the last DL grant will be sent using CCEs in the mapped part. PUCCH efficiency can be greatly improved by allocating only one PUCCH resource for each bundled AN.

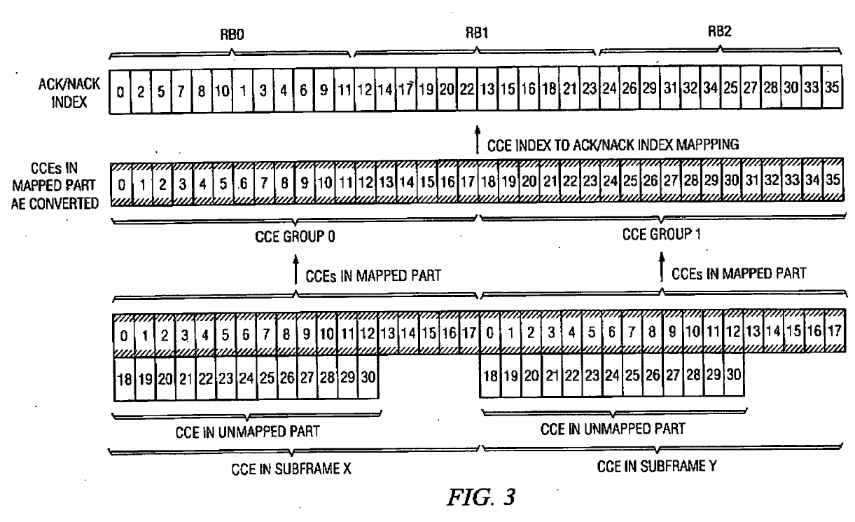

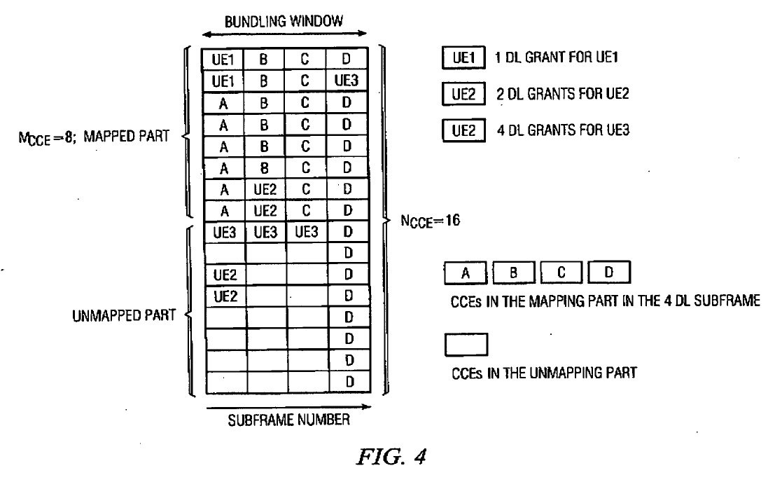

FIGS. 3 and 4 shows examples for implementing exemplary embodiments of the invention. FIG. 3 shows an exemplary embodiment implementing PUCCH compression with CCE division. FIG. 4 shows an exemplary embodiment implementing PUCCH compression with respect to DL grant transmission. As shown in FIG. 4, there are 4 DL grants for UE3 and only the last DL grant is sent with CCEs in the mapped part. The other DL grants are sent with CCEs in the unmapped part and, thus, only one PUCCH resource is mapped.

In some exemplary embodiments, the PUCCH index corresponding to the PDSCH in the m-th DL subframe in a bundling window is determined implicitly by equation (1) or (2). For example, the use of equation (1) instead of equation (2) may depend on the order of subframes when converting the CCEs in the mapping part in each DL subframe. For example, when the subframe order as in FIG. 3 is used, equation (2) should be used, while with the reverse order proposed in the indexing provisional, equation (1) should be used.

$$\begin{matrix}{n}_{PUCCH , m}^{( 1 )} = ( {n}_{CCE} + {\sum }_{i = m + 1}^{M - 1} {N}_{CCE}^{i} ) + {N}_{PUCCH}^{( 1 )} \\ or & ( 1 ) \\ {n}_{PUCCH , m}^{( 1 )} = ( {n}_{CCE} = {\sum }_{i = 0}^{m - 1} {N}_{CCE}^{i} ) + {N}_{PUCCH}^{( 1 )} & ( 2 )\end{matrix}$$

In these two equations, Nⁱ_{CCE} is the number of CCEs in the i-th DL subframe in the bundle window which have mappings to PUCCH resource(s), and M is the bundling window size. The compression method described by the above-noted exemplary embodiments allows N_{CCE}ⁱ<N_{CCE}^{M-1}=N_{CCE} for i=0,1, . . . , M-2, thus greatly reducing reserved PUCCH resources.

In some exemplary embodiments, to reduce signaling overhead, a same value can be set for N_{CCE}¹, i.e, N_{CCE}ⁱ=M_{CCE} for i=0,1, . . . , M-2, as shown in FIG. 4. In the special case when N_{CCE}^{o}=N_{CCE}¹= . . . =N_{CCE}^{M-1}=N_{CCE}, one can use a simplified equation of:

n_{PUCCH,m}⁽¹⁾=(n_{CCE}+(M−M−1)×N_{CCE})+N_{PUCCH}⁽¹⁾ (3)

In some exemplary embodiments, signaling is used to indicate the division of CCEs in each DL subframe, e.g., the value for N_{CCE}ⁱ. Though the CCE division for different DL subframes within the bundling window can be different, i.e., N_{CCE}ⁱ can be different for each DL subframe, to reduce the signaling overhead a common value, such as N_{CCE}ⁱ=M_{CCE}, may be applied.

While FIG. 3 may resemble elements of R1-081816, the R1-081816 proposal has the CCEs in a second part map to the same ACK resource as the first part. This is in direct contrast to exemplary embodiments of the instant invention, wherein the second part does not map to a same ACK resource. Moreover, exemplary embodiments of the invention allow N_{CCE}ⁱ<N_{CCE}^{M-1}=N_{CCE} for i=0,1, . . . , M-2, thus enabling fewer CCEs in the mapping part in the first M-1 DL subframes than that in the last DL subframe.

In some exemplary embodiments of the invention, the value of the parameter N_{CCE}ⁱ is flexible such that it can take on at least two values (e.g., Mⱼ). For example, in the last subframe in a bundling window of size M, N_{CCE}^{M-1} could take on a first value M₁ or a second value M₂. This enables the DL allocation window for the last subframe to be “open.” Such an exemplary embodiment would reduce the effect(s) of blocking by hashing functions, for example. Such configurations or signaling related to M₁ and M₂ could be handled over RRC or other system level configuration, as non-limiting examples.

As noted above, exemplary embodiments of the invention may be implemented with those described in the indexing provisional. For example, equation (1) can be used for this interworking. In one non-limiting, exemplary embodiment, the combined scheme can be as follows:

Divide the CCEs in each DL subframe except the last DL subframe in the bundling window into a mapped part and an unmapped part. CCEs in the mapped part are mapped to PUCCH resource(s) according to the principles described in the indexing provisional, while CCEs in the unmapped part are left unmapped. Let the last DL grant for a UE be sent only from CCEs in the mapped part, while other DL grants for the UE are sent from CCEs in the unmapped part. In case the unmapped part is fully occupied or fully empty, other DL grants can also be sent from CCEs in the mapped part. In this case, the principles described in the indexing provisional will help with compression.

In various exemplary embodiments of the invention a last DL grant is sent to a UE using CCEs that are mapped to resources (e.g., UL resources, PUCCH resources). This last DL grant may or may not be located in a last DL subframe of the bundling window. As a non-limiting example, consider a case where there are four DL subframes in the bundling window. Two DL grants may be sent to the UE. The first DL grant may be sent in the first DL subframe, for example, using CCEs that are not mapped to resources. The second (last) DL grant may be sent in the third DL subframe of the bundling window using CCEs that are mapped to the resources.

As described herein, the CCEs for one or more of the DL subframes in the bundling window are divided into a plurality of portions (e.g., at least two portions comprising a first portion and a second portion). The size of the respective portions may be the same or it may be different (e.g., different for one or more of the portions). As a non-limiting example, consider a case where the CCEs for a DL subframe (e.g., at least one DL subframe) in the bundling window are divided into two portions: a first portion whose CCEs are mapped to resources (e.g., UL resources, PUCCH resources) and a second portion whose CCEs are not mapped to the resources. The size of the second portion is L CCEs, where 0<L<N_{S} and N_{S} is a total number of CCEs in the DL subframe.

The exemplary embodiments of the invention may be utilized in conjunction with carrier aggregation. That is, bundling in the frequency domain or in both time and frequency domains may be used to reduce the number of ACK/NACK feedbacks. That is, multiple ACK/NACKs in frequency/time domain are bundled together and sent using only one PUCCH resource, in a similar way as bundling in the time domain In such a case, it is possible that CCEs in one or more carriers of each DL subframe of the bundling window may be divided into a plurality of portions, for example, if frequency-domain-bundling is enabled.

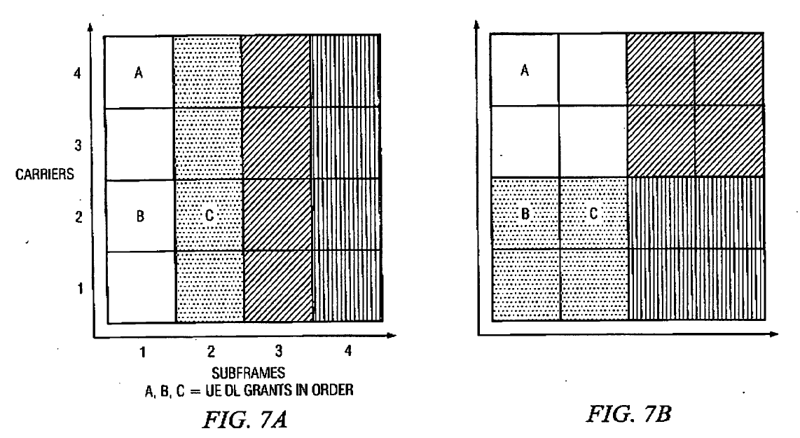

FIG. 7 shows two exemplary distributions of UE DL grants among four DL subframes in the time domain and four carriers in the frequency domain Different shadings and patterns indicate different bundling windows. Thus, in this example there are four bundling windows. In FIG. 7A, one bundling window corresponds to one column, i.e., with four carriers per DL subframe. In FIG. 7B, one bundling window corresponds to two carriers over two DL subframes. With carrier aggregation, one bundling window may include multiple carriers over multiple DL subframes, for example, as shown in FIG. 7B,. In this case, utilizing exemplary embodiments of the invention, the method will be to divide CCEs in each carrier and each DL subframe of a bundling window into the plurality of portions (e.g., at least two portions comprising a first portion and a second portion). A first portion maps to PUCCH resources while a second portion does not map to PUCCH resources.

Consider a case where three DL grants (A, B, C) are assigned to a UE as shown in FIGS. 7A and 7B. In FIG. 7A, the second DL grant (B) is in CCEs that do not map to PUCCH resources, while the first (A) and third (C) DL grants are in CCEs that map to PUCCH resources. This is because the first and third DL grants are the last DL grants in the respective bundling windows. In FIG. 7B, the first and third DL grants are in CCEs that map to PUCCH resources.

The exemplary embodiments of the invention can provide a number of advantages. ACK collision can be avoided since there is no ACK resource remapping. The PUCCH is utilized more efficiently since only one PUCCH resource is reserved for a bundled AN. In addition, some unnecessary AN transmissions from the UE can be avoided since, from the CCE position for the DL grant, the UE can detect whether or not the last DL grant is missing. If the last DL grant is missing, the UE can DTX. Otherwise, it can be difficult to detect the missing DL grant with the counter DAI.

Based on the foregoing it should be apparent that the exemplary embodiments of this invention provide methods, apparatus and computer program(s) to provide a principle for use with ACK/NACK bundling. The method includes, in one non-limiting, exemplary embodiment, dividing CCEs in each DL subframe (e.g., each DL subframe except a last DL subframe) within a bundling window (of AN-bundling) into at least a first portion and a second portion, where the first portion comprises CCEs mapped to resources (e.g., PUCCH resources) and the second portion comprises CCEs that are not mapped to resources (e.g., PUCCH resources); and sending a DL grant for a UE in the last DL subframe of the bundling window using (e.g., only using) at least one CCE from the first portion (i.e., at least one mapped CCE). The method may further comprise: sending a DL grant for a UE in a DL subframe other than the last DL subframe of the bundling window using (e.g., only using) at least one CCE from the second portion (i.e., at least one unmapped CCE).

The exemplary embodiments of the invention, as discussed herein and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed herein and as particularly described with respect to exemplary methods, may be implemented in conjunction with a program storage device readable by a machine, tangibly embodying a program of instructions executable by the machine for performing operations. The operations comprise steps of utilizing the exemplary embodiments or steps of the method.

It is noted that any reference herein to “acknowledgement messages” should be construed as corresponding to any suitable acknowledgement message or type of acknowledgement message. As non-limiting examples, “acknowledgement messages” may include positive acknowledgement messages (e.g., ACKs), negative acknowledgement messages (e.g., NACKs) or a combination of positive acknowledgement messages and negative acknowledgement messages (e.g., ACK/NACKs).

Below are provided further descriptions of various non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

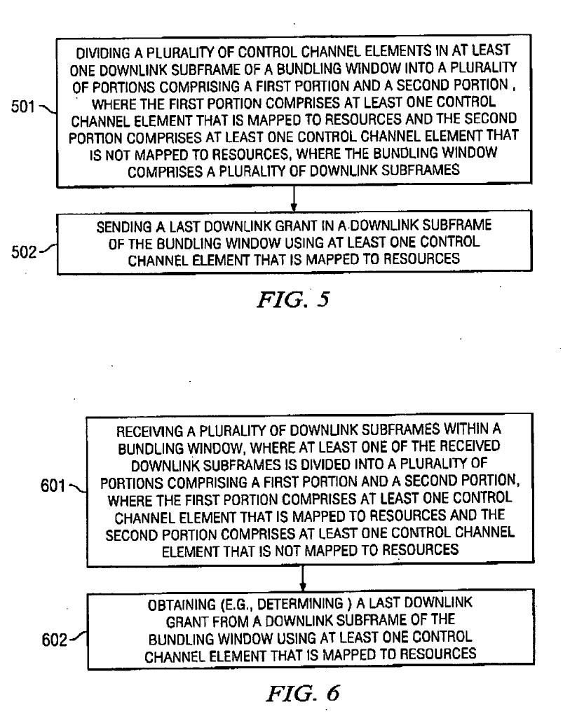

(1) In one exemplary embodiment, and as shown in FIG. 5, a method comprising: dividing a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes (501); and sending a last downlink grant in a downlink subframe of the bundling window using at least one control channel element that is mapped to resources (502).

The method above, where the resources comprise physical uplink control channel resources. A method as in any above, where the resources comprise physical uplink control channel resources to be utilized for sending at least one acknowledgement message regarding the plurality of downlink subframes. A method as in any above, where carrier aggregation is used for at least one downlink subframe of the bundling window and where control channel elements in each carrier and each DL subframe of the bundling window are divided into the plurality of portions except for control channel elements in a last carrier of a last downlink subframe of the bundling window. A method as in any above, further comprising: sending, using at least one control channel element from the second portion, another downlink grant in a downlink subframe of the bundling window other than the downlink subframe having the last downlink grant. A method as in any above, where the method is performed by a base station within an evolved universal terrestrial radio access network. A method as in any above, where carrier aggregation is used for at least one downlink subframe of the bundling window and where the bundling window comprises (e.g., corresponds to) a plurality of carriers and/or a plurality of subframes.

A method as in any above, further comprising: dividing a plurality of control channel elements in another downlink subframe of the bundling window into a plurality of portions comprising a third portion and a fourth portion, where the first portion has a first size and the second portion has a second size, where the third portion has a third size and comprises at least one control channel element mapped to resources, where the fourth portion has a fourth size and comprises at least one control channel element that is not mapped to resources, where the first size does not equal (is different from) the third size and the second size does not equal (is different from) the fourth size.

A method as in any above, where the resources comprise physical uplink control channel resources to be utilized for sending at least one acknowledgement message. A method as in any above, where the last downlink subframe is not divided into a plurality of portions. A method as in any above, where the plurality of portions consists of the first portion and the second portion. A method as in any above, further comprising: sending information via the plurality of downlink frames. A method as in any above, where the method is performed by a base station.

A method as in any above, where the method is performed by a computer program. A method as in any above, where the method is performed by a computer program stored (e.g., tangibly embodied) on a computer-readable medium (e.g., a memory). A method as in any above, where the method is performed as a result of execution of a program of instructions that are tangibly embodied (e.g., stored) on a program storage device (e.g., a memory, a computer-readable medium) readable by a machine (e.g., a processor or a computer). A method as in any above, further comprising one or more aspects of the exemplary embodiments of the invention as described in further detail herein.

In another exemplary embodiment, a program storage device readable by a machine, tangibly embodying a program of instructions executable by the machine for performing operations, the operations comprising: dividing a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes (501); and sending a last downlink grant in a downlink subframe of the bundling window using at least one control channel element that is mapped to resources (502).

The program storage device above, where the program storage device comprises a memory or computer-readable medium. A program storage device as in any above, further comprising one or more aspects of the exemplary embodiments of the invention as described in further detail herein.

In another exemplary embodiment, an apparatus comprising: at least one processor; and at least one memory storing computer program code, the at least one memory and the computer program code configured to, with the at least one processor, cause the apparatus to perform at least the following: divide a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and send a last downlink grant in a downlink subframe of the bundling window using at least one control channel element that is mapped to resources.

The apparatus above, where the apparatus comprises: a base station, an evolved base station (eNode B) or a base station within an evolved universal terrestrial radio access network. An apparatus as in any above, embodied within at least one integrated circuit or at least one integrated circuit module. An apparatus as in any above, further comprising one or more aspects of the exemplary embodiments of the invention as described in further detail herein.

In another exemplary embodiment, an apparatus comprising: means for dividing a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and means for sending a last downlink grant in a downlink subframe of the bundling window using at least one control channel element that is mapped to resources.

The apparatus above, where the means for dividing comprises at least one processor, at least one chip (e.g., at least one ASIC), at least one circuit or at least one integrated circuit and the means for sending comprises at least one transmitter or at least one transceiver. An apparatus as in any above, where the apparatus comprises: a base station, an evolved base station (eNode B) or a base station within an evolved universal terrestrial radio access network. An apparatus as in any above, embodied within at least one integrated circuit or at least one integrated circuit module. An apparatus as in any above, further comprising one or more aspects of the exemplary embodiments of the invention as described in further detail herein.

In another exemplary embodiment, an apparatus comprising: a processor configured to divide a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and a transmitter configured to send a last downlink grant in a downlink subframe of the bundling window using at least one control channel element that is mapped to resources.

The apparatus above, where the apparatus comprises: a base station, an evolved base station (eNode B) or a base station within an evolved universal terrestrial radio access network. An apparatus as in any above, embodied within at least one integrated circuit or at least one integrated circuit module. An apparatus as in any above, further comprising one or more aspects of the exemplary embodiments of the invention as described in further detail herein.

In another exemplary embodiment, an apparatus comprising: processing circuitry configured to divide a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and transmission circuitry configured to send a last downlink grant in a downlink subframe of the bundling window using at least one control channel element that is mapped to resources.

The apparatus above, where the apparatus comprises: a base station, an evolved base station (eNode B) or a base station within an evolved universal terrestrial radio access network. An apparatus as in any above, embodied within at least one integrated circuit or at least one integrated circuit module. An apparatus as in any above, further comprising one or more aspects of the exemplary embodiments of the invention as described in further detail herein.

In another exemplary embodiment, and as illustrated in FIG. 6, a method comprising: receiving a plurality of downlink subframes within a bundling window, where at least one of the received downlink subframes is divided into a plurality of portions comprising a first portion and a second portion, where the first portion comprises at least one control channel element that is mapped to resources and the second portion comprises at least one control channel element that is not mapped to resources (601); and obtaining (e.g., determining) a last downlink grant from a downlink subframe of the bundling window using at least one control channel element that is mapped to resources (602).

A method as in any above, where the method is performed by a computer program. A method as in any above, where the method is performed by a computer program stored (e.g., tangibly embodied) on a computer-readable medium (e.g., a memory). A method as in any above, where the method is performed as a result of execution of a program of instructions that are tangibly embodied (e.g., stored) on a program storage device (e.g., a memory, a computer-readable medium) readable by a machine (e.g., a processor or a computer). A method as in any above, further comprising one or more aspects of the exemplary embodiments of the invention as described in further detail herein.

In another exemplary embodiment, a program storage device readable by a machine, tangibly embodying a program of instructions executable by the machine for performing operations, the operations comprising: receiving a plurality of downlink subframes within a bundling window, where at least one of the received downlink subframes is divided into a plurality of portions comprising a first portion and a second portion, where the first portion comprises at least one control channel element that is mapped to resources and the second portion comprises at least one control channel element that is not mapped to resources; and obtaining (e.g., determining) a last downlink grant from a downlink subframe of the bundling window using at least one control channel element that is mapped to resources.

The program storage device above, where the program storage device comprises a memory or computer-readable medium. A program storage device as in any above, further comprising one or more aspects of the exemplary embodiments of the invention as described in further detail herein.

In another exemplary embodiment, an apparatus comprising: at least one processor; and at least one memory storing computer program code, the at least one memory and the computer program code configured to, with the at least one processor, cause the apparatus to perform at least the following: receive a plurality of downlink subframes within a bundling window, where at least one of the received downlink subframes is divided into a plurality of portions comprising a first portion and a second portion, where the first portion comprises at least one control channel element that is mapped to resources and the second portion comprises at least one control channel element that is not mapped to resources; and obtain (e.g., determine) a last downlink grant from a downlink subframe of the bundling window using at least one control channel element that is mapped to resources.

The apparatus above, where the apparatus comprises: a mobile station, a mobile node, a mobile phone, a cellular phone, a portable electronic device, a user equipment or a user equipment within an evolved universal terrestrial radio access network. An apparatus as in any above, embodied within at least one integrated circuit or at least one integrated circuit module. An apparatus as in any above, further comprising one or more aspects of the exemplary embodiments of the invention as described in further detail herein.

In another exemplary embodiment, an apparatus comprising: means for receiving a plurality of downlink subframes within a bundling window, where at least one of the received downlink subframes is divided into a plurality of portions comprising a first portion and a second portion, where the first portion comprises at least one control channel element that is mapped to resources and the second portion comprises at least one control channel element that is not mapped to resources; and means for obtaining (e.g., means for determining) a last downlink grant from a downlink subframe of the bundling window using at least one control channel element that is mapped to resources.

The apparatus above, where the means for receiving comprises a receiver or a transceiver and the means for obtaining (e.g., means for determining) comprises at least one processor, at least one chip (e.g., at least one ASIC), at least one circuit or at least one integrated circuit. An apparatus as in any above, where the apparatus comprises: a mobile station, a mobile node, a mobile phone, a cellular phone, a portable electronic device, a user equipment or a user equipment within an evolved universal terrestrial radio access network. An apparatus as in any above, embodied within at least one integrated circuit or at least one integrated circuit module. An apparatus as in any above, further comprising one or more aspects of the exemplary embodiments of the invention as described in further detail herein.

In another exemplary embodiment, an apparatus comprising: a receiver configured to receive a plurality of downlink subframes within a bundling window, where at least one of the received downlink subframes is divided into a plurality of portions comprising a first portion and a second portion, where the first portion comprises at least one control channel element that is mapped to resources and the second portion comprises at least one control channel element that is not mapped to resources; and a processor configured to obtain (e.g., to determine) a last downlink grant from a downlink subframe of the bundling window using at least one control channel element that is mapped to resources.

The apparatus above, where the apparatus comprises: a mobile station, a mobile node, a mobile phone, a cellular phone, a portable electronic device, a user equipment or a user equipment within an evolved universal terrestrial radio access network. An apparatus as in any above, embodied within at least one integrated circuit or at least one integrated circuit module. An apparatus as in any above, further comprising one or more aspects of the exemplary embodiments of the invention as described in further detail herein.

In another exemplary embodiment, an apparatus comprising: receiver circuitry configured to receive a plurality of downlink subframes within a bundling window, where at least one of the received downlink subframes is divided into a plurality of portions comprising a first portion and a second portion, where the first portion comprises at least one control channel element that is mapped to resources and the second portion comprises at least one control channel element that is not mapped to resources; and processing circuitry configured to obtain (e.g., to determine) a last downlink grant from a downlink subframe of the bundling window using at least one control channel element that is mapped to resources.

The apparatus above, where the apparatus comprises: a mobile station, a mobile node, a mobile phone, a cellular phone, a portable electronic device, a user equipment or a user equipment within an evolved universal terrestrial radio access network. An apparatus as in any above, embodied within at least one integrated circuit or at least one integrated circuit module. An apparatus as in any above, further comprising one or more aspects of the exemplary embodiments of the invention as described in further detail herein.

In another exemplary embodiment, a system comprising a first apparatus as described above in one of nos. (3), (4), (5) and (6) and a second apparatus as described above in one of nos. (9), (10), (11) and (12). The system above, further comprising one or more aspects of the exemplary embodiments of the invention as described in further detail herein.

The blocks depicted in FIGS. 5 and 6 may also be considered to correspond to one or more functions and/or operations that are performed by one or more components, apparatus, processors, computer programs, circuits, integrated circuits, application-specific integrated circuits (ASICs), chips and/or function blocks. Any and/or all of the above may be implemented in any practicable arrangement or solution that enables operation in accordance with the exemplary embodiments of the invention.

Furthermore, the arrangement of the blocks shown in FIGS. 5 and 6 should be considered merely exemplary and non-limiting. It should be appreciated that the blocks depicted in FIGS. 5 and 6 may correspond to one or more functions and/or operations that may be performed in any order (e.g., any practicable, suitable and/or feasible order) and/or concurrently (e.g., as practicable, suitable and/or feasible) so as to implement one or more of the exemplary embodiments of the invention. In addition, one or more additional steps, functions and/or operations may be utilized in conjunction with those illustrated in FIGS. 5 and 6 so as to implement one or more further exemplary embodiments of the invention, such as those described in further detail herein.

That is, the non-limiting, exemplary embodiments of the invention shown in FIGS. 5 and 6 may be implemented, practiced or utilized in conjunction with one or more further aspects in any combination (e.g., any combination that is practicable, suitable and/or feasible) and are not limited only to the blocks, steps, functions and/or operations illustrated in FIGS. 5 and 6.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. It should thus be appreciated that the exemplary embodiments of this invention may be realized in an apparatus that is embodied in whole or in part as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system TDD mode, it should be appreciated that the exemplary embodiments of this invention are not limited for use with only this mode or only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters, channels and the like (e.g., CCE, PUCCH, PUSCH, PCFICH, etc.) are not intended to be limiting in any respect, as these parameters and channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
dividing a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and
sending a last downlink grant in a downlink subframe of the bundling window using at least one control channel element that is mapped to resources.

2. The method of claim 1, where the resources comprise physical uplink control channel resources.

3. The method of claim 2, where the physical uplink control channel resources are to be utilized for sending at least one acknowledgement message regarding the plurality of downlink subframes.

4. The method of claim 1, where carrier aggregation is used for at least one downlink subframe of the bundling window and where control channel elements in each carrier and each downlink subframe of the bundling window are divided into the plurality of portions except for control channel elements in a last carrier of a last downlink subframe of the bundling window.

5. The method of claim 1, further comprising: sending, using at least one control channel element from the second portion, another downlink grant in a downlink subframe of the bundling window other than the downlink subframe having the last downlink grant.

6. The method of claim 1, further comprising: dividing a plurality of control channel elements in another downlink subframe of the bundling window into a plurality of portions comprising a third portion and a fourth portion, where the first portion has a first size and the second portion has a second size, where the third portion has a third size and comprises at least one control channel element mapped to resources, where the fourth portion has a fourth size and comprises at least one control channel element that is not mapped to resources, where the first size does not equal the third size and the second size does not equal the fourth size.

7. The method of claim 1, where the method is performed by a base station within an evolved universal terrestrial radio access network.

8. An apparatus comprising:
at least one processor; and
at least one memory storing computer program code,
the at least one memory and the computer program code configured to, with the at least one processor, cause the apparatus to perform at least the following:
divide a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and
send a last downlink grant in a downlink subframe of the bundling window using at least one control channel element that is mapped to resources.

9. The apparatus of claim 8, where the resources comprise physical uplink control channel resources.

10. The apparatus of claim 9, where the physical uplink control channel resources are to be utilized for sending at least one acknowledgement message regarding the plurality of downlink subframes.

11. The apparatus of claim 8, where carrier aggregation is used for at least one downlink subframe of the bundling window and where control channel elements in each carrier and each downlink subframe of the bundling window are divided into the plurality of portions except for control channel elements in a last carrier of a last downlink subframe of the bundling window.

12. The apparatus of claim 8, the at least one memory and the computer program code being further configured to, with the at least one processor, cause the apparatus to send, using at least one control channel element from the second portion, another downlink grant in a downlink subframe of the bundling window other than the downlink subframe having the last downlink grant.

13. The apparatus of claim 8, the at least one memory and the computer program code being further configured to, with the at least one processor, cause the apparatus to divide a plurality of control channel elements in another downlink subframe of the bundling window into a plurality of portions comprising a third portion and a fourth portion, where the first portion has a first size and the second portion has a second size, where the third portion has a third size and comprises at least one control channel element mapped to resources, where the fourth portion has a fourth size and comprises at least one control channel element that is not mapped to resources, where the first size does not equal the third size and the second size does not equal the fourth size.

14. The apparatus of claim 8, where the apparatus comprises a base station within an evolved universal terrestrial radio access network.

15. A program storage device readable by a machine, tangibly embodying a program of instructions executable by the machine for performing operations, said operations comprising:
dividing a plurality of control channel elements in at least one downlink subframe of a bundling window into a plurality of portions comprising a first portion and a second portion, where the first portion comprises at least one control channel element that is mapped to resources and the second portion comprises at least one control channel element that is not mapped to resources, where the bundling window comprises a plurality of downlink subframes; and
sending a last downlink grant in a downlink subframe of the bundling window using at least one control channel element that is mapped to resources.

16. The program storage device of claim 15, where the resources comprise physical uplink control channel resources.

17. The program storage device of claim 16, where the physical uplink control channel resources are to be utilized for sending at least one acknowledgement message regarding the plurality of downlink subframes.

18. The program storage device of claim 15, where carrier aggregation is used for at least one downlink subframe of the bundling window and where control channel elements in each carrier and each downlink subframe of the bundling window are divided into the plurality of portions except for control channel elements in a last carrier of a last downlink subframe of the bundling window.

19. The program storage device of claim 15, the operations further comprising: sending, using at least one control channel element from the second portion, another downlink grant in a downlink subframe of the bundling window other than the downlink subframe having the last downlink grant.

20. The program storage device of claim 15, where the machine comprises a base station within an evolved universal terrestrial radio access network.
